(19) United States
(12) Patent Application Publication
(10) Pub. No.: US 2001/0053711 A1
(43) Pub. Date: Dec. 20, 2001

(54) Data shifter with mobile control device

(75) Inventor: Jason Chou, Taipei (TW)

Correspondence Address: Dougherty & Troxell, ONE SKYLINE PLACE, 5205 LEESBURG PIKE, SUITE 1404, FALLS CHURCH, VA, 22041, US

(73) Assignee: Innotek Technology, Inc.

(21) Appl. No.: 09/810,456

(22) Filed: Mar. 19, 2001

(30) Foreign Application Priority Data
Jun. 15, 2000 (TW) 89210215

(51) Int. Cl. H04M 1/00

(52) U.S. Cl. 455/575; 455/556

(57) ABSTRACT

A data shifter with mobile control device comprises a main casing and a mobile control device. The main casing with an opening thereon and further comprises a primary circuit board, a control interface, a control interface, a plurality of connecting interfaces, and a periphery control circuit. The primary circuit board provides electric circuits at the front part and the rear part respectively on a lateral facial side thereof. The control interface at the front side of said main casing connects with electric circuits at the front part of the primary circuit board. The connecting interfaces are at the rear side of said main casing and connect with electric circuits at the rear part of said primary circuit board. The periphery control circuit is at the other lateral facial side of said primary circuit board and provides at least a main connector projecting outward from the primary circuit board opposite to and corresponding to the opening on the main casing. The mobile device is a box or a frame and has a size corresponding to the opening. The mobile device further comprises a secondary circuit board, at least a control chip, and a rear protect plate. The secondary circuit board extends laterally with at least an auxiliary connectors thereon corresponding to the main connector. The control chip has a control program therein is on the auxiliary circuit board. The rear protect plate closes the opening. The secondary connector can engage with and disengage from the primary connector due to the mobile control device being inserted into or taken out from the opening for signal connection or disconnection.

### BACKGROUND OF THE INVENTION

1. Field of The Invention

The present invention relates to a data shifter or known as KVM switch box, and particularly to a data shifter having a mobile control device.

2. Description of Related Art

Due to the development of computer product changing rapidly and the computer system having been kept popularly using, a person operating two or more computers and a company or a factory increasing their main units of computer network become very normal arrangements can be reached. In order to avoid the periphery device for a computer being bought in addition repeatedly and to save the available space, a data shifter, which makes the peripheries such as a set of keyboard, a video device, a display, and a mouse serve multiple computers, was developed for these purposes. Because of progress of technology, the original data shifter with mechanical contact switch for the keyboard, the video device, and the mouse (their combinational abbreviation is known as KVM switch box) has been changed to a data shifter with automatic electronic scanning gradually.

However, the computer has the hardware specification and the operation system thereof kept changed progressively such that the electronic data shifter usually has to be renewed in accordance with the variation of hardware and system structure as soon as the user has renewed the hardware and the operation system. For the user or for the manufacturer having sold the old model of data shifter, a hard problem is how to update the control program.

Presently, a way mostly adopted by the manufacturer making the electronic data shifter mostly adopts is to replace the entire data shifter (i.e. the so called upgraded device). But, this way incurs the user extra expenditure. Alternatively, the user asks the technical person to come over and detach the data shifter for renewing the hardware and the software therein. Although this is a new way for updating the data shifter, it is costly and it is necessary to shut down the connected computer system and detach all connecting wires for disconnect before renewal or replacement. Because the computer system is unable to be operated during renewing or replacing the data shifter, it results in extreme inconvenience to the user. Moreover, it is not possible to renew data shifters for all customers in a short time in case of the manufacturer sending the technical service staff to carry out the job of renewal at each customer place such that it must be resulting in a delay of time and complaint of customers.

### SUMMARY OF THE INVENTION

An object of the present invention is to provide a data shifter with mobile control device, which is possible for a user to renew the mobile control device easily without the need of detaching connecting wires and any other technical person's help.

### BRIEF DESCRIPTION OF THE DRAWINGS

The present invention can be more fully understood by referring to the following description and accompanying drawings, in which:

FIG. 1 is an exploded perspective view of a data shifter according to the present invention; and

FIG. 2 is a perspective view of the data shifter shown in FIG. 1 illustrating the components thereof being assembled together except an upper cover.

### DETAILED DESCRIPTION OF THE PREFERRED EMBODIMENTS

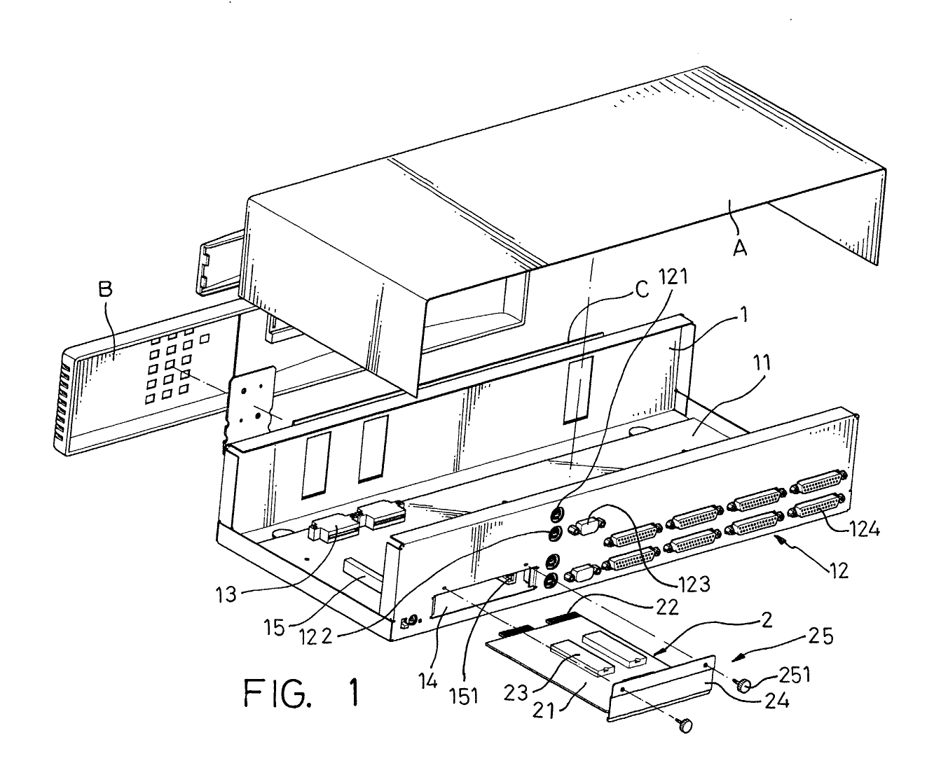

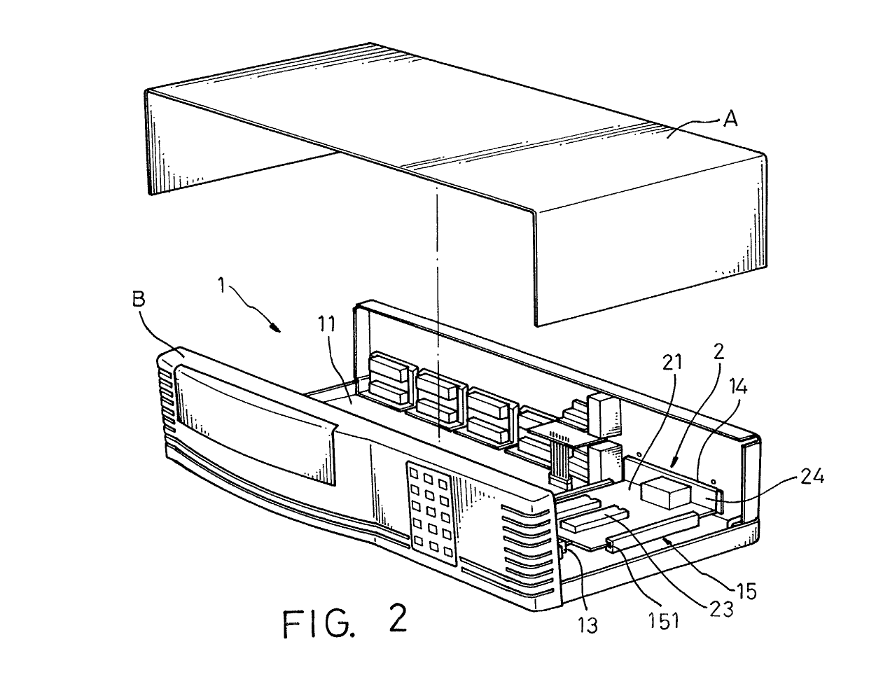

Referring to FIGS. 1 and 2, the data shifter of present invention basically comprises a main casing 1 and a mobile device 2.

Wherein, the main casing 1 is a detachably closed box, that is, the main casing 1 is associated with an upper cover A. The main casing 1 at the front side thereof provides a control panel B and a control interface C, and these are prior art so that no detail will be described further. The main casing 1 is provided with a primary circuit board 11 and the primary circuit board 11 provides electric circuits at the front part and the rear part thereof on one of lateral facial sides thereof to connect with the control interface C and a plurality of connecting interfaces 12. In practice, these connecting interfaces 12 are connectors 121, 122, 123 for connecting with a keyboard, a mouse, and a display respectively, and a plurality of computer connectors 124. The primary circuit board 11 at the other lateral facial side provides a periphery control circuit so as to receive instructions of control interface C for selectively controlling the preceding connecting interfaces 12. In addition, at least a main connector 13 projects outward from the primary circuit board 11 at one of lateral facial sides thereof and the main casing 1 provides an opening 14 at a side edge being opposite to and corresponding to the main connector 13 so as to be feasible for the mobile device 2 detachably inserting into the main casing 2.

Furthermore, the primary circuit board 11 at the portion between the main connector 13 and the opening 14 may be provided with a locating device 15 for the mobile device 2 being withdrawn smoothly and being inserted accurately. In practice, the locating device 15 is comprised of two oppositely positioned slide rails 151 preferably so that a secondary circuit board 21 in the mobile device 2 can move along slide rails 151.

The mobile device 2 is a box or a frame with a size corresponding to the opening 14 and the secondary circuit board 21 extends laterally with auxiliary connectors 22 thereon to correspond to the respective main connector 13. Thus, the auxiliary connectors 22 can engage with the main connectors 13 respectively for signal conduction. Besides, at least a control chip 23 with built-in programs so as to offer the main circuit board 13 control programs. Moreover, a rear protect plate 24 can close the opening 14 tightly by way of conventional fastening device 25. As shown in FIGS. 1 and 2, the fastening device 25 is comprised of screw threads to pass through engaging holes in the rear protect plate 24 and to engage with preset holes surrounding the opening 14 such that the mobile device 2 may be fixedly attached to the main casing 1.

Referring to FIGS. 1 and 2 again, the mobile device 2 is simply aligned with and inserted into the opening 14 while the data shifter of present invention is assembled such that the secondary circuit board 21 can move along two slide rails 151. When the auxiliary connectors 22 engage with main connectors 13, it means the mobile device 2 is in a state of being located. Finally, screw threads 251 are turned by hands to fasten the rear protect plate 24 to the opening 14 tightly. As soon as the data shifter of present invention has been assembled completely, the user can control specific periphery device or the main unit of computer by way of control interface C. When the hardware or the software in the computer is replaced or updated, the user or the supplier is simply needed to take out the mobile device 2 from the main casing 1 such that a new mobile device 2 bearing a new control program can be slid into the data shifter, or the control chip 23 is replaced by one bearing a new control program before the mobile device 2 being slid into the data shifter again. Thus, the connecting lines between the main casing 1 and the connecting interfaces 12 are not necessary to change substantially. It is extremely handy to operate in case of need.

It can be understood from above description with regard to a preferred embodiment of present invention that the present invention offers advantages listed hereinafter:

1) When the data shifter of present invention is produced, an identical main casing can match different control programs (control programs are burned in the control chips) or different control chips to constitute different models. In this way, the pressure of great inventory can be avoided to lower the production cost and to achieve a purpose for obtaining a variety of products.

2) It is convenient for product maintenance and renewal. From the manufacturer side, the inventory can be provided just for replacing new mobile device or for control chips needed to burn new programs therein. From the user side, the sophisticate procedure for detaching all the connecting wires can be avoided and it is not necessary to ask the manufacturer or the distributor for replacing or renewal once a new mobile device can be easily got and he can carry out without any difficulty. Hence, this is an effect to benefit both sides substantially.

3) It is easy for the user to take out the mobile device without the need of any special tool. Because the mobile device is fastened to the main casing at the opening by way of conventional engaging device such as screw threads or retaining projections, it is not necessary to use any other tool for withdrawal of mobile device. Hence, the user can perform to replace the mobile device himself.

4) As soon as an old mobile device from a customer or a distributor is sent to the manufacturer, a new program can be burned into the control chip of respective old mobile device. Thus, a wasteful resource can be avoided and a purpose with regard to reduction of waste can achieved effectively.

5) The present invention provides a great flexibility for being a variety of models. The main casing of present invention can connect with multiple main units in a computer system regardless of the computer system having 2, 4, 6, 8, 16 . . . main units. The only job has to do is to change connecting interfaces and it is not necessary to change the mobile device, which has modularized design.

While the invention has been described with reference to preferred embodiment thereof, it is to be understood that modifications or variations may be easily made without departing from the spirit of this invention, which is defined by the appended claims.

What is claimed is:

1. A data shifter with mobile control device, comprising
a main casing with an opening thereon;
the main casing further comprising
a primary circuit board with two lateral facial sides, providing electric circuits at a front part and a rear part thereof respectively on one of said two lateral facial sides;
a control interface, being at a front side of said main casing, and connecting with electric circuits at the front part of said primary circuit board;
a plurality of connecting interfaces, being at a rear side of said main casing, and connecting with electric circuits at the rear part of said primary circuit board; and
a periphery control circuit, being at the other lateral facial side of said primary circuit board, providing at least a main connector projecting outward from the primary circuit board being opposite to and corresponding to the opening on the main casing; and
the mobile device being a box or a frame with a size corresponding to the opening;
the mobile device further comprising
an secondary circuit board extending laterally with at least an auxiliary connectors thereon corresponding to the main connector;
at least a control chip with control program, being on the secondary circuit board; and
a rear protect plate, closing the opening;
whereby, the secondary connector can engage with and disengage from the primary connector due to the mobile control device being inserted into or taken out from the opening for signal connection or disconnection.

2. The data shifter with mobile control device according to claim 1, wherein each connecting interface is a connector for a keyboard, a mouse, a display connecting with a computer main unit respectively.

3. The data shifter with mobile control device according to claim 1, further comprises a locating device on the primary circuit board at the portion between the main connector and the opening for the mobile device being moved smoothly and being engaged accurately.

4. The data shifter with mobile control device according to claim 3, wherein the locating device is comprised of two oppositely positioned slide rails so that the secondary circuit board in the mobile device can be guided into and move along said slide rails.

5. The data shifter with mobile control device according to claim 1, wherein the control chip can be burned repeatedly.

6. The data shifter with mobile control device according to claim 1, wherein a fastening device is provided between said rear protect plate and the opening so as to fasten the mobile device to the main casing.

7. The data shifter with mobile control device according to claim 6, wherein the fastening device is screw threads passing through preset holes in the rear plate and fastening to a part surrounding the opening.
